(19) United States
(12) Patent Application Publication
(10) Pub. No.: US 2013/0159071 A1
(43) Pub. Date: Jun. 20, 2013

(54) METHOD FOR CONNECTING CUSTOMERS AND BUSINESSES

(71) Applicant: Shawn G. Inks, Richfield, OH (US)

(72) Inventor: Shawn G. Inks, Richfield, OH (US)

(73) Assignee: DAILY REFERRAL, LLC, Broadview Heights, OH (US)

(21) Appl. No.: 13/325,830

(22) Filed: Dec. 14, 2011

(51) Int. Cl. G06Q 30/02

(52) U.S. Cl. 705/14.1

(57) ABSTRACT

According to one aspect of the present invention, a new and improved method for marketing to customers and businesses may comprise the steps of providing a platform on a global computer network for buying and selling of a good and/or service; providing a business, the business selectively offering the good and/or service at a first price, wherein the good and/or service are available for sale outside of the platform at a second price, wherein the first price is less than the second price; and sending a communication from the business via the platform to the customer for the good and/or service at the first price. The customer selects its interests to receive offers from businesses they prefer. The business uses the tools necessary via the platform to market its products or services directly to customers, who have selected preferences or interests that fall into their category.

### I. BACKGROUND OF THE INVENTION

A. Field of Invention

The present application is directed to novel methods for connecting customers and businesses. More specifically, the instant invention is directed to novel methods for connecting customers and businesses on a group purchasing platform on a global computer network.

B. Description of the Related Art

Group purchasing websites, such as Groupon and Living Social, serve as a platform to bring together businesses and customers. The business' goal is to sell more products and services and increase their customer base. Customers are looking for discounted prices at favorite establishments or new places. A commonality of the current platforms is a bottle-neck effect of connecting the customers and businesses. The platform decides which business offers discounted services. As such, customers may receive multiple communications from the platform that are not to the customer's interest. This results in the customer being disinterested. If it occurs frequently enough, the customer may stop engaging the platform all together.

Another shortfall for these websites is that they are static in nature. More specifically, once a business posts a voucher for discounted goods or services that is all the exposure a customer receives. In order to find more information about the business, the customer would need to leave the website and go to the business' webpage. This becomes especially cumbersome when a customer is trying to maneuver through various businesses.

As such, there is a need in the art for a group purchasing website that is specifically tailored to a customer's interests and provides more interaction between the customer and the business. The present invention provides methods for connecting customers and businesses in a meaningful way such that customers receive vouchers for reduced prices of goods and services from businesses that suit their interest, and the customer receives them as often as the businesses make the vouchers available. The present invention also enables the customer to have a more personal interaction with the businesses, which is likely to increase customer loyalty for the businesses.

### II. SUMMARY OF THE INVENTION

According to one aspect of the present invention, a new and improved method for marketing to customers and businesses may comprise the steps of providing a platform on a global computer network for buying and selling of a good and/or service; providing a business, the business selectively offering the good and/or service at a first price, wherein the good and/or service are available for sale outside of the platform at a second price, wherein the first price is less than the second price; providing a customer having an account with the platform, the customer desiring to receive the good and/or service from the business at the first price; and sending a communication from the business via the platform to the customer for the good and/or service at the first price.

Another object of the present invention is to provide a method for marketing to customers and businesses, which may further comprise the step of personalizing at least one interest on the platform by the customer, wherein the communication sent to the customer is related to the one interest.

Further, another object of the present invention is to provide a method for marketing to customers and businesses, wherein the step of sending a communication from the business to the customer for the goods and/or services at the first price may be based from the group comprising answers to customer questionnaires, demographic data, previous purchasing habits, or selected interests.

Still yet, another object of the present invention is to provide a method for marketing to customers and businesses wherein the step of providing a customer having an account with the platform, may further comprise the step of selecting categories of interest.

Yet, another object of the present invention is to provide a method for marketing to customers and businesses wherein the step of selecting categories of interest may further comprise the step of selectively choosing geographic locations for the categories of interest.

Still, another object of the present invention is to provide a method for marketing to customers and businesses wherein the step of providing a customer having an account with the platform may further comprise the step of following activity of the business.

Another object of the present invention is to provide a method for marketing to customers and businesses wherein the step of providing a customer having an account with the platform may further comprise the step of creating a wish list, wherein the wish list is viewable by a third party.

Further, another object of the present invention is to provide a method for marketing to customers and businesses which may further comprise the step of purchasing items via the platform from the wish list by the third party.

Still yet, another object of the present invention is to provide a method for marketing to customers and businesses wherein the business may create a storefront.

Yet, another object of the present invention is to provide a method for marketing to customers and businesses wherein the storefront may comprise updates about the business.

Another object of the present invention is to provide a method for marketing to customers and businesses wherein the updates may comprise events, news, notifications and the offering of the good and/or service.

Further, another object of the present invention is to provide a method for marketing to customers and businesses which may comprises the steps of providing a platform on a global computer network for connecting the customer and the business; the business creating a storefront and selectively posting informational data about the business on the storefront; the customer selecting to receive informational data about the business; the platform accumulating informational data posted by the business; sending a communication to the customer for the informational data.

Another object of the present invention is to provide a method for marketing to customers and businesses wherein the informational data may comprise old informational data and new informational data, wherein the step of sending the communication to the customer for the informational data may be only the new informational data.

Yet, another object of the present invention is to provide a method for marketing to customers and businesses wherein the business may be a generic business type.

Further, another object of the present invention is to provide a method for marketing to customers and businesses wherein the business may be a specific business having an operating address.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a flow chart showing the present invention.

FIG. 2 is a schematic drawing illustrating another aspect of the present invention.

FIG. 3 is a flow chart showing another aspect of the present invention.

FIG. 4 is a flow chart showing another aspect of the present invention.

### IV. DETAILED DESCRIPTION OF THE INVENTION

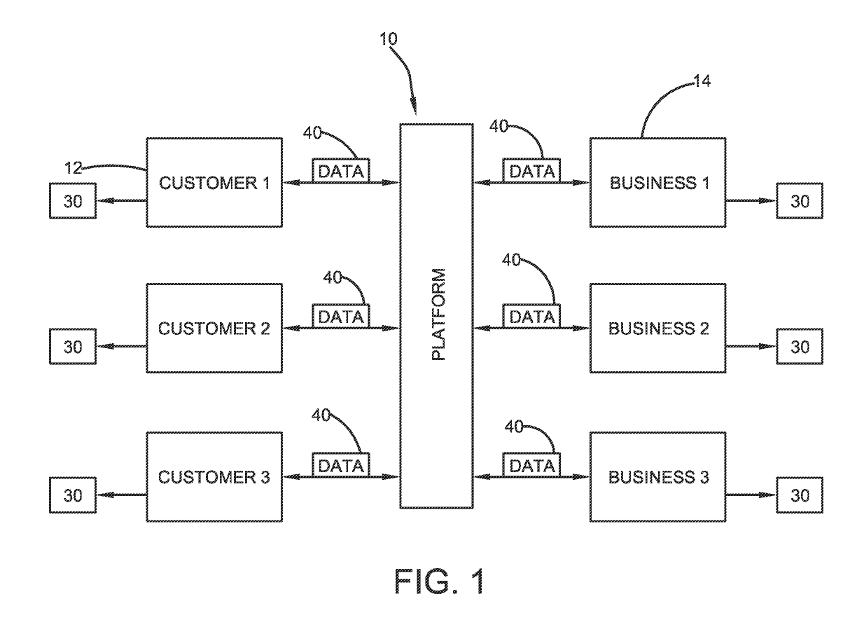

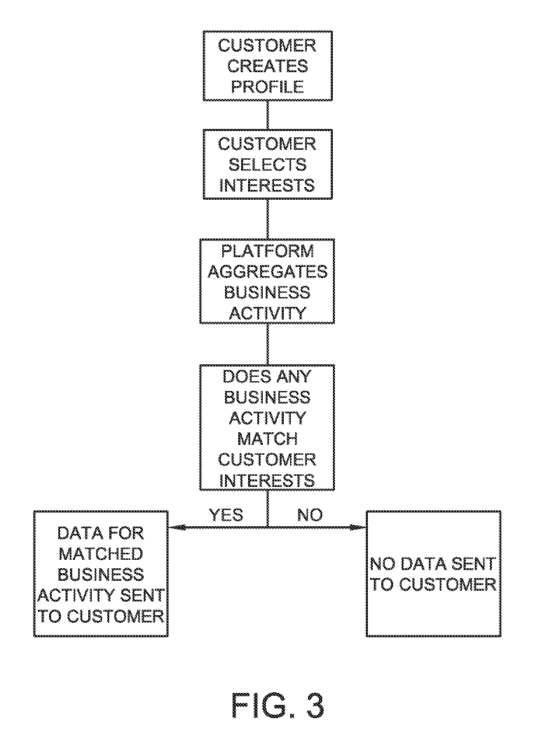

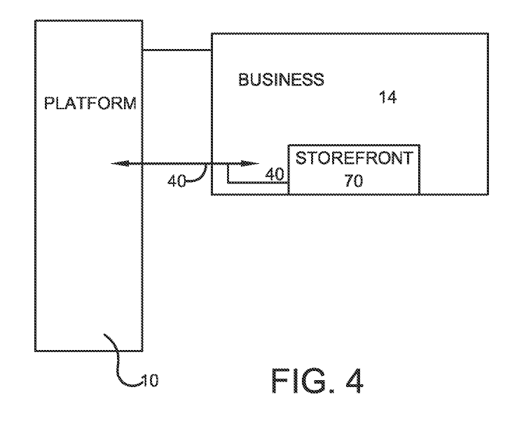

Referring now to the drawings wherein the showings are for purposes of illustrating embodiments of the invention only and not for purposes of limiting the same, FIGS. 1-4 show the present invention. The present invention is the intersection of social media and electronic commerce. Networking commerce as described herein optimizes connections between customers and businesses. Customers receive information and vouchers from businesses of their particular interest. Businesses have increased exposure to old and new customers on a regular systematic basis rather than waiting for their turn to be featured on a traditional discount website. Customers receive vouchers and information tailored to their specific interests. As a result, a synergistic effect occurs between the customers and businesses.

With specific reference to FIG. 1, one aspect of the present invention is shown. A platform 10 serves as the intermediary between a plurality of customers 12 and a plurality of businesses 14. Communications 40 transmitted from the customer 12 to the business 14 or from the business 14 to the customer 12 are sent through the platform 10. Any customer 12, business 14, person or entity utilizing the platform 10 may create an account 30 with the platform 10. Communications 40 may take any form including without limitation, newsletters, vouchers, advertisements, or business updates or activity. Communications may be sent through any medium including without limitation email, text, computer programs or mobile applications.

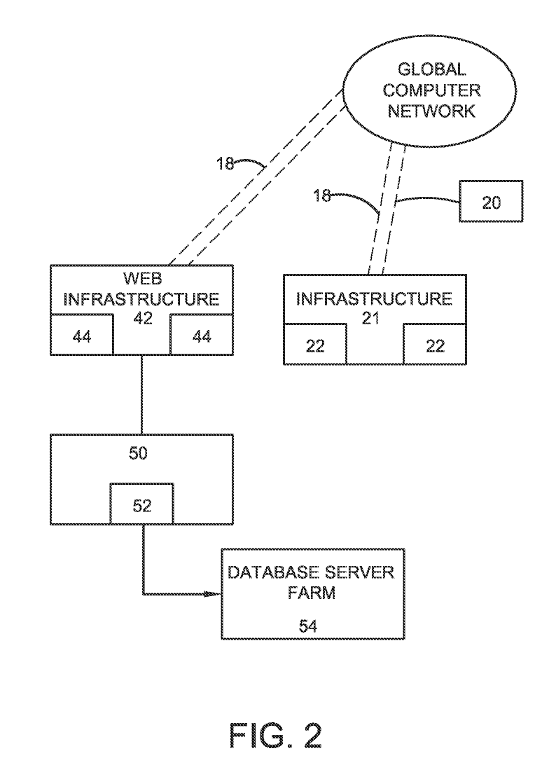

With reference to FIG. 2, infrastructure 21 has redundant pathways to a global computer network 16, which prevent single points of failure from causing the entire platform 10 to fail. The platform 10 may have a website gateway 18. The website gateway may comprise a hardware load balancer 20, which distributes web traffic, meaning any person or entity having an account 30 with the platform, to a plurality of web servers 22. As web traffic increases, the platform 10 is adapted to add more web nodes rendering the platform 10 highly scalable.

Communications 40, such as email, text messages, or other means, are sent between customers 12 and businesses 14 via the platform 10. A separate web infrastructure 42 is utilized with separate servers 44 for the communications 40. This enables the platform 10 to compile, generate and render the communications 40 separate from the normal web traffic to reduce the load on the main site web farm. It also allows the communications 40 infrastructure 42 to scale separate from the main web infrastructure 21.

The present invention also comprises a database infrastructure 50 that also has a load balancer 52 that distributes database traffic to a database server farm 54. That enables the present invention to have redundant nodes of the database thus ensuring uptime and performance.

When the customer 12 creates its account 30 with the platform, the customer 12 provides a variety of information in order to create a customer profile. Customer interests may be based from the group comprising answers to customer questionnaires, demographic data, previous purchasing habits, or selected interests. Such information may include without limitation demographic data such as date of birth, address, ethnicity, employment data, religious affiliation, and phone numbers. The customer may also designate certain interests, including without limitation, hobbies, sports teams, sports in general, restaurants, events, art, entertainment, news, finance, politics, movies or music, or any other point of interest. When points of interest are designated by the customer 12, the designation may be anywhere along a continuum between very broad to very specific.

By way of a nonlimiting example, if customer 1, as shown in FIG. 1, has a general interest in restaurants, customer 1 can specify restaurants, Italian food, Thai food, and French Cuisine with their profile. Customers 12 could also designate what he or she is not interested in viewing via the platform 10. In the ongoing nonlimiting example, Customer 1 could designate that it has no interest in Mexican food. It could also choose his or hers interest by specific business location, such as ABC Pizza Company on South Main Street in Hometown, Ohio.

Businesses 14 also have an account 60 with the platform 10. Businesses have the ability to send communications to customers 12 via the platform 10. Businesses may post any information it desires. However, which customers receive that information depends upon each customer's information provided in their specific profile. In one embodiment of the present invention, businesses 14 can send communication to customers 12 as frequently as desired. Generally, businesses may send a daily communication via the platform 10. Customers 12 will receive communications only if businesses 14 match the interests it selected in its profile.

By way of nonlimiting example, with reference to FIG. 1, assume customers 1-4 have an interest in running Customer 1 selected “running” in general as part of its selected information. Customer 2 lives in California, and selects “running only in California” as part of its selected information. Customer 3 lives in Florida and selects “running” and also selects Florida. Now assume Businesses 1-3 are running organizations in California, Florida and Maine respectively. Each business sends out a communication about its local marathon. Customer 1 will receive a communication from all three businesses because he or she did not restrict its preference with running Customer 2 will only receive the communication from the California Business, and Customer 3 will only receive the communication from the Florida business.

In another embodiment of the present invention, the platform 10 assists with marketing and connecting customers 12 and businesses 14. The method comprises of steps of providing the platform 10 on the global computer network such as the internet. The businesses 14 may be selling a good and/or a service. The business 14 selectively offers the good and/or service at a first price. The first price is different from a second price. The second price is available to the general public. Generally the first price is less than the second price. The customer desires to receive the good or service from the business at the first price and takes action to purchase the good or service at the first price. Upon receipt of the customer's purchase, businesses then send communication via the platform to the customer for the goods and services at the first price in the form of a voucher.

In another aspect of the present invention, customers 12 may redeem its vouchers electronically, for example through its mobile device or its computer. Alternatively, customers may redeem its vouchers by presenting a hard copy to the business at the time of redemption. Still further, the unique voucher can provide a redemption code used online to place an order on a separate business website. Regardless of mode of redemption, the voucher is verified through the platform's database. If is confirmed to be a valid voucher, the redemption occurs and the database updated accordingly to reflect the redeemed status.

Another inventive aspect of the present invention are business storefronts 70. Each business having its account with the platform is able to create a storefront 70. The storefront is a custom designed website page which provides endless information about that business. The information about the business may be updates, events, coupons, specials, or other areas of interest that the particular business would want to display on the storefront. Such information can also include news and notifications. Nonlimiting examples may include discounted goods and or services, new store openings, the business being highlighted in the media, or the business hosting any type of event.

In another embodiment of the present invention, customers are able to view any business storefront 70 through the platform 10. When viewing a business' storefront 70, customers are able to select to follow a business. By following a business, the customer will receive communication any time new information or updates are posted by the business on its storefront 70. When the business has any type of activity on its storefront, the customer will be notified. For example, if a business is hosting a band at its location and adds that information to its storefront, customers who follow that business will receive that particular information, which would likely include time, duration and any ticket price. Further, if there is a change to that information, such as the date, the business can update its storefront to notify all of its following customers.

When a business offers a voucher for discounted goods or services, there are two ways customers may receive that information. First, the customers proactively chose to follow the business. Alternatively, or in addition to, the customer's profile contained selected interests that match the goods or services offered by the business.

In another embodiment of the present invention, customers only receive information relating to business activity a single time. More specifically, communications received by the customer may only contain new information. In yet another embodiment of the present invention, customers receive communication daily, such as a daily email. The timing for receiving the information may be selected by the platform, the business, or the consumer. As such, the communications may be received by the consumer daily, weekly, bi-weekly or in real time.

In another embodiment of the present invention, customers are also able to create a wish list on the platform 30 which is viewable by third parties. The wish list may be selected from goods or services offered by the businesses 14. Third parties also having accounts with the platform 30 are able to purchase goods and or services from the wish list through the platform.

It is contemplated to be within the scope of the invention to have the platform available through a variety of mediums. The platform may be accessed through a computer or mobile device. The platform may take the form of downloadable software, a smart phone application, or a web-based application. Any form chosen with sound engineering judgment may be utilized and still be encompassed within the scope of the present invention.

The embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

What is claimed is:

1. A method for marketing to customers and businesses, comprising the steps of:
providing a platform on a global computer network for buying and selling of a good and/or service;
providing a business, said business selectively offering said good and/or service at a first price, wherein said good and/or service are available for sale outside of said platform at a second price, wherein said first price is less than said second price;
providing a customer having an account with said platform, said customer desiring to receive said good and/or service from said business at said first price; and
sending a communication from said business via said platform to said customer for said goods and/or services at said first price.

2. The method of claim 1, further comprises the step of:
personalizing at least one interest on said platform by said customer, wherein said communication sent to said customer is related to said one interest.

3. The method of claim 2, wherein said step of sending a communication from said business to said customer for said goods and/or services at said first price is based from the group comprising answers to customer questionnaires, demographic data, previous purchasing habits, or selected interests.

4. The method of claim 1, wherein the step of providing a customer having an account with said platform, further comprises the step of:
selecting categories of interest.

5. The method of claim 4, wherein said step of selecting categories of interest, further comprises the step of:
selectively choosing geographic locations for said categories of interest.

6. The method of claim 1, wherein the step of providing a customer having an account with said platform, further comprises the step of:
following activity of said business.

7. The method of claim 1, wherein the step of providing a customer having an account with said platform, further comprises the step of:
creating a wish list, wherein said wish list is viewable by a third party.

8. The method of claim 7, further comprising the step of:
purchasing items via said platform from said wish list by said third party.

9. The method of claim 1, wherein said business creates a storefront.

10. The method of claim 9, wherein said storefront comprises updates about said business.

11. The method of claim 10, wherein said updates comprise events, news, notifications and said offering of said good and/or service.

12. A method for connecting a customer and a business, comprising the steps of:
providing a platform on a global computer network for connecting said customer and said business;
said business creating a storefront and selectively posting informational data about said business on said storefront;
said customer selecting to receive informational data about said business;
said platform accumulating informational data posted by said business;
sending a communication to said customer for said informational data.

13. The method of claim 12, wherein said informational data is comprises old informational data and new informational data, wherein said step of sending said communication to said customer for said informational data is only said new informational data.

14. The method of claim 12, wherein said business is a generic business type.

15. The method of claim 12, wherein said business is a specific business having an operating address.

16. The method of claim 12, wherein said informational data further comprises a good and/or service at a first price, wherein said good and/or service is available for sale outside of said platform at a second price, wherein said first price is less than said second price;

17. The method of claim 12, wherein said informational data comprises updates including events, news, notifications and said offerings of said good and/or service.

18. The method of claim 12, further comprising the step of:
personalizing at least one interest on said platform by said customer, wherein said communication sent to said customer is related to said one interest.

19. The method of claim 18, wherein said step of sending a said customer for said informational data is based from the group comprising answers to customer questionnaires, demographic data, previous purchasing habits, or selected interests.

20. A method for connecting a customer and a business, comprising the steps of:
providing a platform on a global computer network for connecting said customer and said business;
said business creating a storefront and selectively posting new informational data and historical information about said business on said storefront, said new and said historical informational data comprising;
a good and/or service at a first price, wherein said good and/or service is available for sale outside of said platform at a second price, wherein said first price is less than said second price; and
updates including events, news, and notifications;
said customer selecting to receive informational data about said business;
said platform accumulating informational data posted by said business;
sending a communication to said customer for said new informational data, wherein said communication sent to said customer is based from the group comprising customer's answers to customer questionnaires, demographic data, previous purchasing habits, or selected interests.
